(19) United States
(12) Patent Application Publication
(10) Pub. No.: US 2017/0260485 A1
(43) Pub. Date: Sep. 14, 2017

(54) SCREEN-WASH LIQUID FOR A VEHICLE WINDSHIELD

(71) Applicant: Valeo Systèmes d'Essuyage, Le Mesnil Saint Denis (FR)

(72) Inventors: Marcel Trebouet, Le Mesnil Saint Denis (FR); Giuseppe Grasso, Issoire (FR); Grégory Kolanowski, Issoire (FR)

(73) Assignee: Valeo Systèmes d'Essuyage, Le Mesnil Saint Denis (FR)

(21) Appl. No.: 15/515,434

(22) PCT Filed: Oct. 2, 2015
(86) PCT No.: PCT/EP2015/072848

§ 371 Date: Mar. 29, 2017

(30) Foreign Application Priority Data
Oct. 3, 2014 (FR) 1459467

(51) Int. Cl. C11D 11/00; C11D 1/83; B60S 1/04; C11D 3/50; B60S 1/46; C11D 3/20; C11D 3/04

(52) U.S. Cl. CPC C11D 11/0035; C11D 3/2068; C11D 1/83; C11D 3/044; C11D 3/50; C11D 3/2017; B60S 1/46; B60S 1/04; C11D 1/66

(57) ABSTRACT

Liquid screen-wash for vehicle windscreen, comprising between 0.01% and 10% by weight of a surfactant or of a mixture of surfactants, between 5% and 15% by weight of a glycol ether, and water.

### TECHNICAL FIELD

The present invention relates to a screen-wash liquid for the windshield of a vehicle, in particular a motor vehicle.

### PRIOR ART

Motor vehicles are commonly equipped with windshield-wiper systems for wiping and washing the windshield and preventing the driver's view of his environment from being obstructed. These systems comprise arms that perform an angular to-and-fro motion, at the end of which are installed elongated windshield-wiper blades, which themselves bear scraper blades made of an elastic material. The blades rub against the windshield and evacuate the water by conveying it out of the driver's field of vision.

Windshield-wiper systems may comprise means for spraying screen-wash liquid onto the windshield. These spraying means may be located on the hood, on the window grid of the windshield or, in a more recent version, on the windshield-wiper arms, in particular for blades of the flat-blade type, i.e. for blades which are themselves cambered to allow them to be mounted on the arms without intermediary fixing stirrups or yoke plates.

In the current art, screen-wash liquids for motor vehicles are designed to be sprayed onto the windshield and wiped off immediately by the windshield-wiper blades. They must not leave marks once wiped off and dried. They have very limited detergent power and their action time is short. Windshield-wiper systems using these conventional screen-wash liquids have relatively poor performance in particular with respect to the cleaning of windshields soiled with insect impacts.

The present invention proposes a simple, efficient and economic solution to this problem.

### DISCLOSURE OF THE INVENTION

The invention proposes a screen-wash liquid for the windshield of a vehicle, comprising:
between 0.01 and 10% by weight of a surfactant or of a mixture of surfactants,
between 5 and 15% by weight of a glycol ether,
and water.

As a result of this particular formulation, the screen-wash liquid according to the invention has increased detergent power when compared with the screen-wash liquids of the prior art. In particular, the glycol ether, which is preferably butyl glycol (or 2-butoxyethanol), has relatively high wetting and dissolving power. It is a sparingly volatile, inexpensive organic solvent with relatively efficient surface-agent properties. Its concentration in the screen-wash liquid is between 5 and 15%, and preferably between 8 and 12%, for example 10% (by weight or “w/w”). The screen-wash liquid is thus relatively concentrated in glycol ether to reinforce its detergent power. A glycol ether dissolves readily in water. It may thus be readily removed by rinsing. As will be explained hereinbelow, the screen-wash liquid has a glycol ether concentration such that it must be removed by rinsing, after spraying onto a windshield, so as not to leave traces on this windshield.

Advantageously, the screen-wash liquid comprises a mixture of an anionic surfactant and of a nonionic surfactant. This surfactant mixture optimizes the detergent power of the liquid. A nonionic surfactant has the advantage of having good dispersing, antifoam and emulsifying powers, and an anionic surfactant has the advantage of having good wetting and emulsifying powers. Moreover, an anionic surfactant can limit the risk of redepositing soiling due to the interactions between the charges borne by the anionic surfactants of the micelles containing the soiling and those borne by the anionic surfactants covering the windshield. The surfactants may be readily removed by rinsing.

The screen-wash liquid may comprise an alcohol ethoxylate, preferably at between 0.01 and 5% by weight. An alcohol ethoxylate is a nonionic surfactant. Use may be made, for example, of Tergitol® 15-s-7, which is a polyethoxylated secondary alcohol. It comprises a chain of 9 to 11 carbon atoms (C9-11) and 5 ethoxy groups. It has an HLB (hydrophilic/lipophilic balance) of 12.1 and its CMC is 7.5×10⁻⁵ mol·L⁻¹. It may be present in large majority in the screen-wash liquid relative to another surfactant.

The screen-wash liquid may comprise sodium lauryl sulfate, preferably at between 0.01 and 1% by weight. Sodium lauryl sulfate or sodium dodecyl sulfate is an anionic surfactant with a high HLB (40). Use may be made, for example, of Sulfopon® N70. It has a CMC of 7×10⁻³ mol·L⁻¹. It may be present in small proportion in the screen-wash liquid relative to another surfactant.

The weight ratio between the anionic surfactant and the nonionic surfactant is, for example, between 1:5 and 1:10.

As a variant, the screen-wash liquid may comprise an alkylbenzene sulfonate or a polyethoxylated alkyl sulfate as anionic surfactant.

The surfactant or the mixture of surfactants of the screen-wash liquid preferably has an HLB of between 12 and 14. This makes it possible to ensure the wetting and detergent powers of the surfactant(s).

The surfactant or the mixture of surfactants preferably has a CMC (critical micelle concentration) of between 6×10⁻³ and 8×10⁻³ moL·L⁻¹.

The screen-wash liquid according to the invention may comprise one or more of the following additives:
a base, such as ammonia (NH₃), sodium hydroxide (NaOH) or potassium hydroxide (KOH), for example at between 0.05 and 1% by weight,
at least one fragrance (such as S-limonene), for example at between 0.01 and 1% by weight,
at least one colorant, for example at between 0.01 and 1% by weight,
isopropanol, for example at between 5 and 10% by weight,
dipropylene glycol monomethyl ether (DPGME), for example at between 0.1 and 5% by weight, this product having good wetting and dissolving powers, and
sodium sulfite, for example at between 0.1 and 1%, this product making it possible to destroy disulfide bonds and thus to degrade the three-dimensional structures of proteins, in particular of organic matter derived from insect impacts on the windshield.

The screen-wash liquid according to the invention may comprise between 70 and 80% by weight of water.

The screen-wash liquid advantageously has a pH of between 7 and 10, preferably between 9 and 10, more preferentially between 9.5 and 9.8, for example about 9.7. This pH makes it possible to ensure the detergent power of the liquid, to prevent impairment of the surfactant(s) and to facilitate the dissolution of proteins.

The present invention also relates to a screen-wash container for a vehicle, containing a screen-wash liquid as described above.

The present invention also relates to a use of the screen-wash liquid as described above for washing the windshield of a vehicle.

Finally, the present invention relates to a process for washing the windshield of a vehicle using a windshield-wiper system of this vehicle, characterized in that it comprises the steps consisting in:
a) spraying the screen-wash liquid as described above onto the windshield and sweeping the windshield using at least one blade of the windshield-wiper system so as to spread the liquid over the windshield,
b) spraying rinsing liquid onto the windshield and sweeping the windshield using said at least one blade, each of the steps a) and b) possibly being followed by a waiting step during which said at least one blade remains immobile.

Step a) of the process makes it possible to spray and spread the screen-wash liquid according to the invention on the windshield of the vehicle. Since this liquid comprises a relatively high concentration of glycol ether, it has a tendency to leave traces on the windshield of the vehicle after drying. It is thus necessary to rinse the windshield in order to prevent the appearance of these traces or to make them disappear, which is performed by means of step b) of the process. In this step, rinsing liquid such as water is sprayed onto the windshield, which is also wiped to remove the screen-wash liquid.

Each of the steps a) and b) may be followed by a waiting step during which the windshield-wiper blade(s) remain immobile. The waiting step between steps a) and b) allows the screen-wash liquid time to act, especially for the purpose of degrading the organic matter of insect impacts. The waiting time after step b) allows the rinsing liquid to correctly dilute the screen-wash liquid remaining on the windshield, and may be followed by a final step of wiping the windshield to remove the majority of the liquids deposited thereon.

Preferably, the screen-wash liquid is sprayed on using one or two windshield-wiper blades of the flat blade type, equipped with at least one sprinkler array.

### DETAILED DESCRIPTION

The invention will be better understood and other details, characteristics and advantages of the invention will emerge on reading the following description comprising nonlimiting examples of formulation of the screen-wash liquid according to the invention.

### Example 1: Composition of a Screen-Wash Liquid According to the Invention

| Compounds | Mass percentages |
|---|---|
| Butyl glycol | 5-15 |
| DPGME | 0-5 |
| Alcohol ethoxylate (Tergitol ® 15-s-7) | 0-5 |
| Sodium lauryl sulfate | 0.01-0.1 |
| Water | 70-80 |
| Isopropanol | 5-10 |
| S-Limonene | 0-5 |
| Sodium sulfite | 0.1-1 |

### Example 2: Results of Tests Performed after Spraying Screen-Wash Liquids According to the Invention onto a Windshield

θ represents the contact angle of the screen-wash liquid on the windshield and thus reflects the wetting and spreading power of the liquid. The lower the contact angle, the better the spreading.

Four formulations (BG1 to BG4) of screen-wash liquid according to the invention were tested (these formulations comprising mass percentages of nonionic surfactant of between 0 and 2.5% and mass percentages of glycol ether of between 5 and 10%). Three contact angle measurements were taken following the deposition of a liquid onto, respectively, a clean windshield, a windshield covered with egg (protein) and a windshield comprising insect impacts. The pH of the various liquid formulations was also measured.

| | θ Clean | θ Wind- | θ Wind- | |
|---|---|---|---|---|
| | wind- | shield + | shield + | |
| Formulations | shield | egg | insects | pH |
| BG1 (5% glycol ether) | 5 | 24 | 26 | 9.7 |
| BG2 (5% glycol ether) | 5 | 29 | 27 | 8.7 |
| BG3 (10% glycol ether) | 8 | 33 | 17 | 8.7 |
| BG4 (5% glycol ether) | 5 | 23 | 25 | 9.4 |

The results show that the presence of glycol ether in relatively high concentration in the liquid makes it possible to obtain relatively low contact angles θ on a clean windshield, which was expected due to the high wetting power of the glycol ether.

They also show that formulations BG1 and BG4 have a higher pH than the other formulations (BG2 and BG3), which has a positive effect on the dissolution of proteins (egg) and on the spreading of the screen-wash liquid (reduction of the contact angle θ).

The results also show that the glycol ether has a positive effect on the dissolution of insect impacts, since the contact angle obtained with formulation BG3 (comprising 10% glycol ether) is lower than those obtained with the other formulations (comprising 5% glycol ether).

1. A semen-wash liquid for the windshield of a vehicle, comprising:
between 0.01 and 10% by weight of a surfactant or of a mixture of surfactants;
between 5 and 15% by weight of a glycol ether;
and water.

2. The screen-wash liquid as claimed in claim 1, wherein the glycol ether is butyl glycol.

3. The screen-wash liquid as claimed in claim 1, further comprising a mixture of an anionic surfactant and of a nonionic surfactant.

4. The screen-wash liquid as claimed in claim 1, further comprising between 0.05 and 1% by weight of one selected from a group consisting of: ammonia, sodium hydroxide or potassium hydroxide.

5. The screen-wash liquid as claimed in claim 1, wherein the liquid has a pH of between 9.5 and 9.8.

6. The screen-wash liquid as claimed in claim 1, further comprising between 0.01 and 1% by weight of at least one fragrance.

7. The screen-wash liquid as claimed in claim 1, further comprising between 0.01 and 1% by weight of at least one colorant.

8. The screen-wash liquid as claimed in claim 1, further comprising an alcohol ethoxylate, at between 0.01 and 5% by weight, and/or sodium lauryl sulfate, at between 0.01 and 1% by weight.

9. The screen-wash liquid as claimed in claim 1, wherein the surfactant or the mixture of surfactants has an HLB of between 12 and 14.

10. The screen-wash liquid as claimed in claim 1, wherein the surfactant or the mixture of surfactants has a CMC of between 6×10⁻³ and 8×10⁻³ mol·L⁻¹.

11. The screen-wash liquid as claimed in claim 1, further comprising dipropylene glycol monomethyl ether, at between 0.1 and 5% by weight.

12. The screen-wash liquid as claimed in claim 1, further comprising between 5 and 10% by weight of isopropanol.

13. The screen-wash liquid as claimed in claim 1, wherein the liquid has between 70 and 80% by weight of water.

14. The use of the screen-wash liquid as claimed in claim 1, for washing the windshield of a vehicle.

15. A method for washing the windshield of a vehicle using a windshield-wiper system of this vehicle, comprising:
spraying screen-wash liquid as claimed in claim 1 onto the windshield;
sweeping the windshield using at least one blade of the windshield-wiper system so as to spread the liquid over the windshield;
spraying rinsing liquid onto the windshield; and
sweeping the windshield using said at least one blade,
wherein each of the steps of spraying and sweeping is followed by a waiting step during which said at least one blade remains immobile.
